(19) United States
(12) Patent Application Publication
(10) Pub. No.: US 2024/0025042 A1
(43) Pub. Date: Jan. 25, 2024

(54) NEURO-CAPABILITY PLUG-INS FOR ROBOT TASK PLANNING

(71) Applicant: Intel Corporation, Santa Clara, CA (US)

(72) Inventors: David Gonzalez Aguirre, Portland, OR (US); Leobardo Campos Macias, Guadalajara (MX); Rafael De La Guardia Gonzalez, Teuchitlan (MX); Javier Felip Leon, Hillsboro, OR (US); David Gomez Gutierrez, Tlaquepaque (MX); Edgar Macias Garcia, Jalisco (MX); Javier Turek, Beaverton, OR (US); Julio Zamora Esquivel, West Sacramento, CA (US)

(21) Appl. No.: 18/478,747

(22) Filed: Sep. 29, 2023

(51) Int. Cl. B25J 9/16

(52) U.S. Cl. CPC B25J 9/1664; B25J 9/163; B25J 9/1607; B25J 9/161

(57) ABSTRACT

A component of a robotic system, including: processor circuitry; and a non-transitory computer-readable storage medium including instructions that, when executed by the processor circuitry, cause the processor circuitry to: train a neuro-capability map plugin, which is a continuous or semi-continuous resolution neural network component encoded with kinematic capability attributes with respect to an action to be performed by a robot in a workspace; and publish the neuro-capability map plugin to a robotic skills repository where it is obtainable by robotic controller circuitry for embedding within a neural network usable perform one or more inferences to control the robot to perform the action.

### BACKGROUND

Robot planning systems use voxelized capability maps that represent reachable workspaces of robots for manipulation or tool application through discrete volumetric regions. These approaches focus on creating and exploiting look-up tables structured either in dense grid arrays or via semi-sparse octrees. Such data structures empower methods to evaluate a robot's reachable regions, determining if the voxels are feasible for an atomic grasping or tool action.

### BRIEF DESCRIPTION OF THE FIGURES

FIG. 1 illustrates a schematic diagram of a robotic system in accordance with aspects of the disclosure.

FIG. 2 illustrates an example of a neuro-capability map plugin and robot in accordance with aspects of the disclosure.

FIGS. 3A-3E illustrate graphs related to artificial neural network (ANN) training in accordance with aspects of the disclosure.

### DETAILED DESCRIPTION

The aspects of this disclosure relate to a neuro-capability map plug-in that may be efficiently shared among devices. The plugin is a neural network component that is a map representation used for scene inspections or robot navigation.

### I. Overview

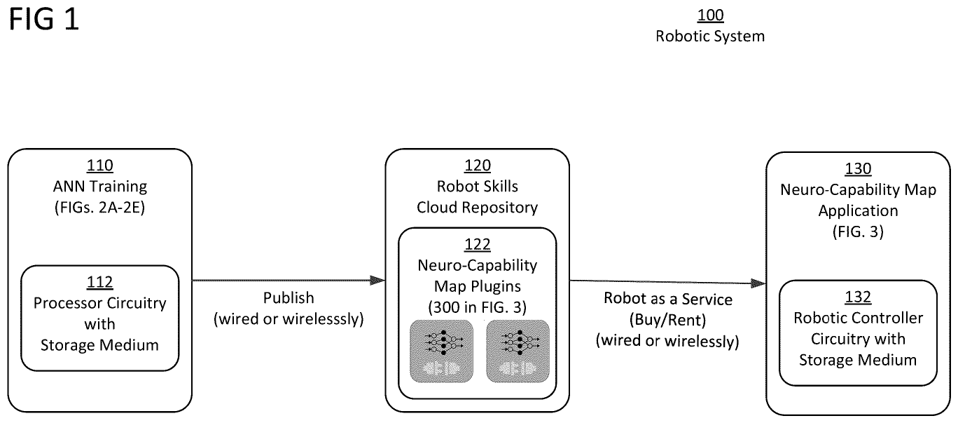

FIG. 1 illustrates a schematic diagram of a robotic system 100 in accordance with aspects of the disclosure.

The robotic system 100 may be conceptually divided into three main phases: artificial neural network (ANN) training 110, storage in a robot skills repository 120, and neuro-capability map application 130.

Broadly, the ANN training 110 encompasses the process of training a neuro-capability map plugin 122. This trained plugin 122 is then published and made available in the robot skill repository 120, which could be hosted in a cloud-based environment, for instance. In the context of application 130, this neuro-capability map plugin 122 can subsequently be downloaded (e.g., rented or purchased) and embedded in a neural network.

In the process of training, the processor circuitry 112 is operable to train the neuro-capability map plugin 122. This neuro-capability map plugin 122 is a neural network component encoded with kinematic attributes relevant to the execution of tasks by a robot within a given workspace. The neuro-capability map plugin 122 has continuous or semi-continuous resolution. The specific resolution is design-specific, but higher than a resolution resulting from previous robotic systems using voxels and lookup tables. Following the training, the processor circuitry 112 publishes the neuro-capability map plugin 122 to the robotic skills repository 120. This repository 120 serves as a resource that can be accessed by the robotic controller circuitry 132 downloading and embedding the neuro-capability map plugin 122 into a neural network. This robotic controller circuitry 123 can then perform one or more inferences, facilitating the control of the robot's actions in its workspace.

A neuro-capability plugin 122 is a compact neural network component responsible for encapsulating a robot's capabilities concerning specific actions via weights and biases. These actions could encompass tasks like grasping, placing, or tactile interactions. When a robot is tasked with executing a particular action that demands precise operations, it is crucial for the robot to comprehend the feasible range of parameters, including force and orientation. This understanding is vital as not all conceivable actions can be successfully accomplished by a particular robot.

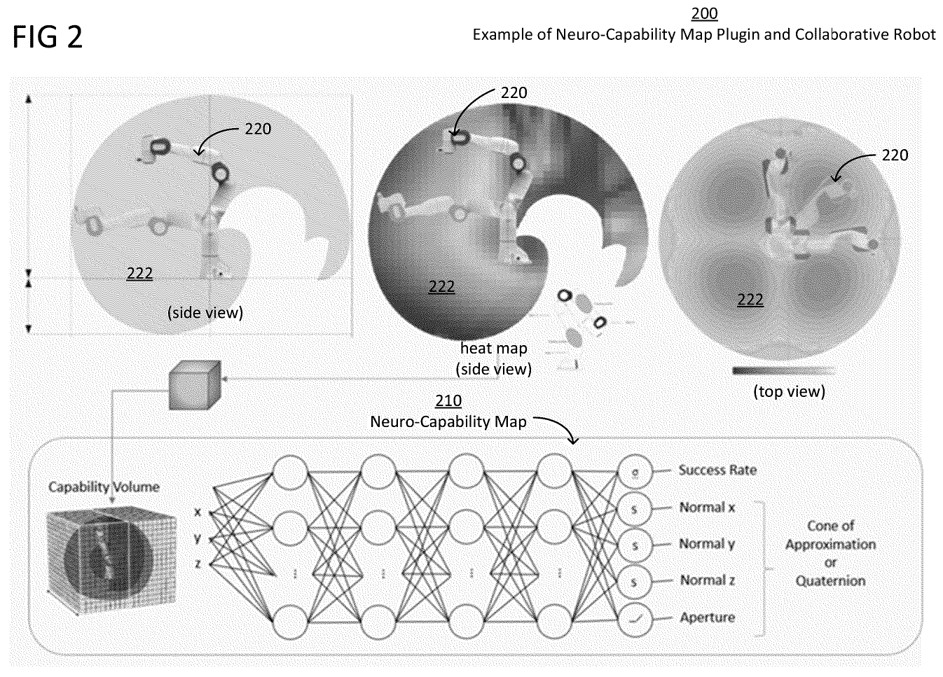

FIG. 2 illustrates an example 200 of a neuro-capability map plugin 210 and robot 220 in accordance with aspects of the disclosure.

The three images arranged horizontally at the top of the figure represent the reachability space 222 of the robot 220 from different perspectives: a side view, a side view with a heat map overlay, and a top view, respectively. The reachability space 222 is of course not likely cuboid in shape; rather, its configuration is likely intricate and contingent upon the robot's 220 specific shape, configuration, and degrees of freedom.

The neuro-capability map plugin 210 operates by receiving input, consisting of a specified point or location within the workspace relative to the robot's base 220, along with the desired action. While the input points/locations can be expressed in Cartesian coordinates (x, y, z), this disclosure does not impose any limitations in this regard. The neuro-capability map plugin 210, comprising multiple internal layers, is designed to learn and encode a capability function. The resultant kinematic capability attributes generated by this plugin 210 may encompass various parameters, such as the success rate (output as a sigmoid a), normal vector as a three-dimensional normalized SoftMax output, and the aperture of the cone as a non-negative scalar (rectified linear unit (ReLU)). The action by the robot is likely to be successful when the success rate index is greater than a threshold index, for example. Importantly, this disclosure is not limited to these specific kinematic capability attributes provided.

### II. Spatial Complexity and Temporal Complexity

The neuro-capability map plugin 210 offers scalability in both size and dimension to accommodate various robot workspaces. Unlike previous systems that rely on discrete voxels, this neuro-capability map plugin 210 employs semi-continuous or continuous resolution. Its delivery mechanism as a plugin-in ensures high compression ratios, making it effective, hardware-independent, and capable of rapid application (on-demand transfer) over private or public networks. Additionally, it offers flexible monetization options, such as (AI-robotics as a service, inference licensing, or time-based licensing. At its core, the plug-in 210 relies on multilayer perceptron (MLP) (or another suitable ANN topology) to approximate large spatial functions ψ(x)→R^{k} with input queries represented as continuous points x∈R³.

The neuro-capability map plugin 210 possesses spatial complexity, enabling it to encode large volumes with compression ratios ranging from 100 to 1000 times greater than look-up tables. Furthermore, it requires relatively small storage for neural weights, making it compatible with a wide range of hardware. It can also take advantage of neural accelerators for improved performance. Furthermore, the neuro-capability map plugin 210 is small enough to be storable within the central processing circuitry of a robotic controller 132 such that during inference, accessing long-term storage is not required. Additionally, the neuro-capability map plugin 210 may be compressed before it is published to the robotic skills repository 120.

This neuro-capability map plugin 210 also exhibits temporal complexity, as it meets stringent latency constraints with MLPs, enabling real-time utilization of multi-sampling probability methods with low energy consumption. Single forward passes within an MLP are highly optimized for various XPUs (e.g., CPUs, GPUs, VPUs, FPGAs) through efficient pipelines. Multiple forward passes are even more energy-efficient, enabling robust Bayesian and frequentist/voting approaches commonly used in robotics. Additionally, it offers high throughput for queries, maintains constant latency, and generates minimal memory traffic, resulting in significant energy savings for low-power ANN engines. This feature also enables the robotic controller 132 to perform a plurality of inferences to infer a plurality of respective inference results, and select an inference result having a highest success rate index for the robot 220 to perform the action. The action is then later performed after the robotic controller 132 performs path planning.

### III. Resolution Granularity and Coherence Between Neuro-Capability Map Plugin 210 and Robot 220

Previous systems relied on discrete voxels. However, these approaches have limitations in accurately representing information within voxel borders with abrupt transitions across borders. While interpolation could mitigate this, the process considers only local information. In contrast, neuro-capability map plugin 210 operates by mapping a continuous space to another continuous space of attributes, offering continuous or semi-continuous resolution.

Semi-continuous resolution is achievable using MLPs because they act as a function approximation where the singularity manifold and cuspidal regions are tightly approximated to obtain robust and dependable models in a manageable manner. This is feasible because queries are point-wise possible at all and any location. This approach is well-suited for robots operating in large workspaces while performing ultra-precise tasks.

During the training process, the quantity and spatial distribution of kinematic simulations (capability process samples) are deliberately controlled to ensure high local representativeness and consistency, particularly across and close to critical kinematic regions. Due to the off-line and robot-specific nature of the neuro-capability plug-ins 210, singularities and cuspidal regions are closely approximated using gradient descent over the determinant of the Jacobian |j(Θ)|. In other words, the joint space of the robot 220 is sampled at a non-regular resolution that is inversely proportional to a gradient descent over a Jacobian determinant such that the sampling resolution is proportional to proximity to a singularity or cuspidal region. This permits the number of samples and their joint-space locations to be determined automatically through a kinematic tree-tessellation, with pruning criteria based on the Jacobian determinant volume and a minimal sampling radius in the task space. While the computational cost is considerable, it is a one-time effort per robot-action pair, with the action being performable by the robot any number of times, offering efficiency and distributability.

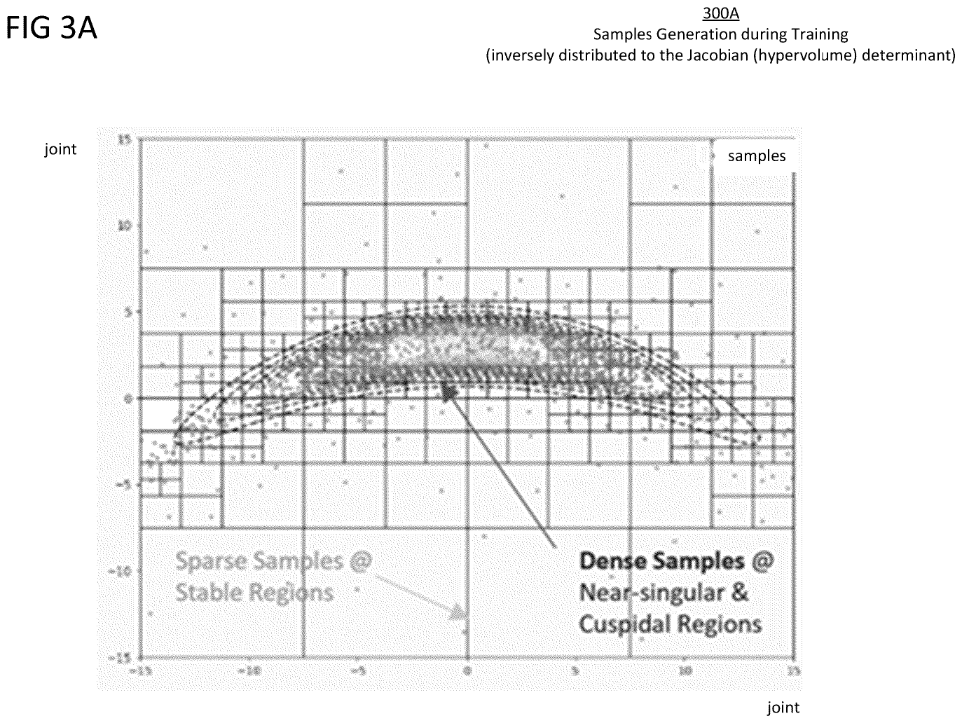

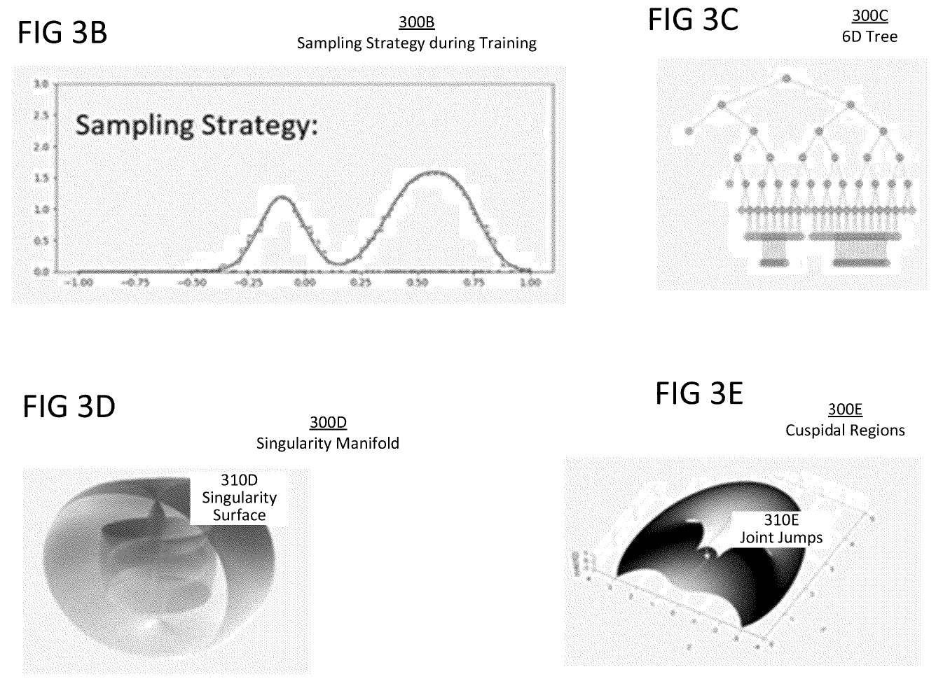

FIG. 3A illustrates a graph 300A of sample generation within a joint space. The shading in the graph 300A corresponds to the determinant of the Jacobian at each specific point. A determinant value of zero indicates the presence of a singularity or a cuspidal region, and the closer to these regions, the finer the sampling resolution. This is evident in the grid, which displays boxes of varying sizes. This enhanced sampling strategy results in more precise training. Consequently, when the neuro-capability plugin 310 is employed during inference, the output exhibits greater accuracy.

FIG. 3B illustrates a graph 300B of an example of a sampling strategy. FIG. 3C illustrates a six-dimensional tree 300C. FIG. 3D illustrates a graph 300D of a singularity manifold having a singularity surface 310D. FIG. 3E illustrates a graph of cuspidal regions showing joint jumps 310E.

Furthermore, the neuro-capability map plugin 210 enhances coherency and dependability by embodying a model that either provides a solution or, alternatively, a rationale for the absence of a solution, creating a new level of explainable AI (via the hypervolume of the Jacobian's determinant) and trustworthiness for users. At each point, the function approximation determines the proximity to a critical zone (singularity or cuspidal boundary), the solution will be either asserted as valid at that point or rejected as unsuitable based on the determinant of the Jacobian |j(Θ)| at that configuration.

### IV. Enhanced Procedural Cues

The neuro-capability map 210 has the capacity to store more than just a single value; it can also incorporate additional attributes. Instead of representing the success rate of an action as a binary 0 or 1, it can encompass a continuous range of values. Additional attributes can provide guidance on which normal the robot 220 should approach. The normal is not only a single fixed orientation, it may define a range or cone of possible orientations, giving the robot 220 information on the angles it can use to approach a location or the orientation for placing its end effector.

The neuro-capability maps 210 enable the mapping ψ(x)→R^{k} to any R^{k} representation. The encoding is not limited to real-value outputs like graspability indices; it can also capture critical cues such as the orientation or orientation cone for the action to be conducted by the robot. A single query at a point in the workspace x∈R³ provides the feasibility of a complex task, including specifying the approach orientation. Additional cues may be integrated on a case-by-case basis. The cohesive point-wise solution can encode binary and scalar cues, as well as multivariate cues exploitable as orientations, approximation cones, partial trajectory, and geometric primitives, among other cues. This feature not only serves as a plausibility check but also as a partial solution generator for complex problems. Furthermore, the input query extended beyond x∈R³ to y∈R³⁺ⁿ, accommodating additional custom attributes linked to an implicit x volumetric map.

### V. Monetization: On-Demand, Network-Transparent Neuro-Capability Maps 210

The neuro-capability map plugin 210 can be integrated into an ANN as a compressed, encrypted binary component, available for rental or purchase alongside a specific robot or platform. Due to the compact nature and adaptability of the neuro-capability map plugin 210, this facilitates the growth of the robotics industry and minimizes energy consumption during robot training, thereby enhancing sustainability.

### VI. Peripersonal Robot Capabilities

A. Forward and Backward Kinematics Discretization

When analyzing the reachable space of a robot arm, the construction kinematics define a volume within which the robot can reach and exert force to perform various actions. Furthermore, there are two functional mappings that establish connections between the internal, observable, and controllable joint states of the robot 220 and its end-effector. The first mapping, referred to as forward kinematics, is represented as:

\vec{F}(θ∈Rⁿ)→T_{b}^{e}∈SE³. (Equation 1)

This mapping transforms n≥6 joint angles (or degrees of freedom) of the robot arm into a rigid transformation depicting the position and orientation of the end-effector frame relative to the robot's base. Since most robots possess six or more degrees of freedom (redundancy), and joint angles are encoded with exceptionally fine granularity (to 1/100 of a degree), directly applying the forward kinematic function in dynamic programming is not suitable. Additionally, a coarser discretization is also not directly productive due to the complex nature of mapping joint space to Cartesian space, which can result in ripples, gaps, singularities, and cuspidal regions, depending on the robot's topology. On the contrary, a regular discretization of space into voxels vᵢ⊂R³: i∈N³, where the center of each implicit cube determines the existence and value of joint angles (joint configuration) results in:

\vec{F}⁻¹= [symbol] (vᵢ∈R\hat{ }3)→(Ω(θ)⊂Rⁿ)|Ø. (Equation 2)

This represents an unconstrained solution or solution subspace, as a single point only provides position information without specifying orientation.

The disclosed aspects pertain to the process of sampling a collection of orientations denoted as Λ, which is defined as:

Λ={w₁,w₂, . . . ,wₘ}, (Equation 3)

In this context, the normal vectors |wᵢ|=1 are uniformly distributed on the surface of the sphere, where m=192 (geodesic sphere or higher depending on application and ANN size desired follow the solution to the Thomson problem.) Using this sample orientation, is it possible to obtain a sample frame denoted as T_{b}^{s} and expressed as:

T_{b}^{s}=[wᵢ,wⱼ,wᵢ×wᵢ,vᵢ], (Equation 4)

Here, (wᵢ,wⱼ) are selected orthogonally and simultaneously wᵢ×wᵢ to ensure that the end effector is pointing to the center of the voxel vg. This is possible keeping the robot operating system standard of end-effector configuration. Finally, it is possible to compute the inverse kinematic represented by the mapping:

[symbol]

(T_{b}^{s}∈SE³) (Equation 5)

of each sampled by

[symbol]

(T_{b}^{s}∈SE³)→(θₛ∈Rⁿ)|Ø. (Equation 6)

This mapping does not always find a solution, namely:

[symbol]

(T_{b}^{s}∈SE³)=Ø. (Equation 7)

The set of feasible solutions Δ⊂Λ define a region on the geodesic sphere described by an orientation vector wₛ and aperture angle 0≤αₛ≤π over the geodesic sphere. This approximation over all voxels vᵢ is computational large but feasible considering its application will remain relevant as long has the kinematic map does not changes \vec{F}(θ∈Rⁿ), namely if the robot is not physically modified.

B. Task-Planning & Motion Planning

Motion planning for a robot manipulator, whether it is a static or mobile system, entails determining a viable path from the current position of the robot's end effector to a desired end effector pose. This path allows the robot to perform tasks like grasping, provided that the end effector pose is within the robot's reach. In the context of the disclosed aspects, an end effector pose is considered reachable if it surpasses a predefined threshold according to the capability index calculated using the disclosed model. The capability index reflects several critical aspects, including the presence of distinct inverse kinematics solutions and the null space for redundant manipulators. Additionally, it should account for factors that affect reachability, such as joint limitations, external obstacles, energy consumption, and more.

Multiple methods can be employed for planning, one of which is reinforcement learning, where the capability index can function as a reward signal. On a higher level, task planning is responsible for determining the where, how, and why of object manipulation. The capability index consolidates a multitude of complex, interconnected factors that would otherwise demand advanced cognitive abilities in robots to process effectively.

C. Learning and Optimizing the Capability Maps

To mitigate the impact on data size, the disclosed approach employs neural networks to store information derived from the simulated data. The neural network takes the voxel's position in the peripersonal space as input and produces both the success rate and capability information as output. During training, the simulated data is used in a supervised learning manner. In contrast to a generalization scenario, here the neural network is trained to learn from all the simulated data, focusing exclusively on the robot's reachability limit. This allows the neural network to interpolate information across the entire peripersonal space. The lookup table is condensed by encoding each voxel's information into a continuous function spanning the entire space.

Furthermore, the neural network approach offers the advantage of reduced memory requirements for storing (compressing) simulation data within the neural network's weights. The neural network model can accommodate various types of output as needed. For instance, the rectifier linear unit function can yield non-negative values, the SoftMax function can provide normalized vectors, and the sigmoid function can output success rates within the (0, 1) interval. Consequently, the model concurrently delivers the success rate alongside directional information, such as the cone of approximation (including the normal vector and cone aperture). Alternatively, the model could generate a quaternion.

In some cases, it is possible to train a more generalized (albeit larger in terms of parameter size) neural network that takes a specific action and voxel position as input and produces capability information for that action at that position. This approach has the added benefit of compressing simulated data for multiple actions, even though it sacrifices the per-action modularity achieved by using one neural network per action, which necessitates increasing the neural network's capacity (size) to accommodate it.

To incorporate new actions, the disclosed approach requires retraining the neural network. Once the neural network has been trained for each action, its architecture and parameters can be serialized for use during inference. This model serialization facilitates efficient transfer of the model for various use cases while conserving storage space. Specifically, memory space and network communication can be exchanged for computational resources. Depending on the precision needed for a specific action and the onboard hardware of the robot, the neural networks can be optimized to reduce computational requirements, for example, through techniques like quantization and pruning.

The techniques of this disclosure may also be described in the following examples.

Example 1. A component of a robotic system, comprising: processor circuitry; and a non-transitory computer-readable storage medium including instructions that, when executed by the processor circuitry, cause the processor circuitry to: train a neuro-capability map plugin, which is a continuous or semi-continuous resolution neural network component encoded with kinematic capability attributes with respect to an action to be performed by a robot in a workspace; and publish the neuro-capability map plugin to a robotic skills repository where it is obtainable by robotic controller circuitry to embed within a neural network usable perform one or more inferences to control the robot to perform the action.

Example 2. The component of example 1, wherein the instructions, when executed by the processor circuitry, may further cause the processor circuitry to: publish the neuro-capability map plugin in a form of neural network component with weights and biases.

Example 3. The component of any of examples 1-2, wherein the instructions, when executed by the processor circuitry, may further cause the processor circuitry to: train the neuro-capability map plugin by sampling a joint space of the robot at a resolution that is inversely proportional to a gradient descent over a Jacobian determinant.

Example 4. The component of any of examples 1-3, wherein the instructions, when executed by the processor circuitry, may further cause the processor circuitry to: train the neuro-capability map plugin by sampling a joint space of the robot at a resolution that is proportional to a proximity to a singularity or cuspidal region such that a higher resolution of samples are captured closer to the singularity or cuspidal region.

Example 5. The component of any of examples 1-4, wherein the instructions, when executed by the processor circuitry, may further cause the processor circuitry to: train the neuro-capability map plugin off-line once per robot-action pair.

Example 6. The component of any of examples 1-5, wherein the action is performable by the robot a plurality of times using the neural network with the neuro-capability map plugin embedded therein.

Example 7. The component of any of examples 1-6, wherein the kinematic capability attributes comprise a success rate index of the action, wherein the action is likely to be successful when the success rate index is greater than a threshold index.

Example 8. The component of any of examples 1-7, wherein the kinematic capability attributes comprise a multivariate cue exploitable as an orientation, an approximation cone, a partial trajectory, a geometric primitive, or another expressive geometric.

Example 9. The component of any of examples 1-8, wherein the instructions, when executed by the processor circuitry, may further cause the processor circuitry to: compress the neuro-capability map plugin before the neuro-capability map plugin is published to the robotic skills repository.

Example 10. The component of any of examples 1-9, wherein the compression is performed by binary lossless compression or a bit quantization of the neural network.

Example 11. The component of any of examples 1-10, wherein the neural network with the neuro-capability map plugin embedded therein is storable within central processing circuitry of a robotic controller.

Example 12. The component of any of examples 1-11, wherein central processing circuitry of a robotic controller is operable to perform a plurality of inferences using the neural network with the neuro-capability map plugin embedded therein to infer a plurality of respective inference results, and to select an inference result of the plurality of respective inference results having a highest success rate index for the robot to perform the action.

Example 13. The component of any of examples 1-12, wherein the robotic skills repository is hosted in a cloud-based environment.

Example 14. A robotic system, comprising: a robot; and robotic controller circuitry operable to: obtain, from a robotic skills repository, a neuro-capability map plugin, which is a continuous or semi-continuous resolution neural network component encoded with kinematic capability attributes with respect to an action to be performed by a robot in a workspace; and represent and store the neuro-capability map plugin into a neural network.

Example 15. The robotic system of example 14, wherein the robotic controller circuitry is further operable to: perform an inference using the neural network with the neuro-capability map plugin embedded therein; perform path planning based on a result of the inference; and control the robot to perform the action based on a planned path.

Example 16. The robotic system of any of examples 14-15, wherein the robotic controller circuitry is further operable to: perform a plurality of inferences using the neural network with the neuro-capability map plugin embedded therein; select or process an inference result having a highest success rate index for the robot as a probabalistic model of the action; and control the robot to perform the action based on the selected inference result.

While the foregoing has been described in conjunction with exemplary aspect, it is understood that the term “exemplary” is merely meant as an example, rather than the best or optimal. Accordingly, the disclosure is intended to cover alternatives, modifications and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1. A component of a robotic system, comprising:
processor circuitry; and
a non-transitory computer-readable storage medium including instructions that, when executed by the processor circuitry, cause the processor circuitry to:
train a neuro-capability map plugin, which is a continuous or semi-continuous resolution neural network component encoded with kinematic capability attributes with respect to an action to be performed by a robot in a workspace; and
publish the neuro-capability map plugin to a robotic skills repository where it is obtainable by robotic controller circuitry to embed within a neural network usable perform one or more inferences to control the robot to perform the action.

2. The component of claim 1, wherein the instructions, when executed by the processor circuitry, may further cause the processor circuitry to:
publish the neuro-capability map plugin in a form of neural network component with weights and biases.

3. The component of claim 1, wherein the instructions, when executed by the processor circuitry, may further cause the processor circuitry to:
train the neuro-capability map plugin by sampling a joint space of the robot at a resolution that is inversely proportional to a gradient descent over a Jacobian determinant.

4. The component of claim 1, wherein the instructions, when executed by the processor circuitry, may further cause the processor circuitry to:
train the neuro-capability map plugin by sampling a joint space of the robot at a resolution that is proportional to a proximity to a singularity or cuspidal region such that a higher resolution of samples are captured closer to the singularity or cuspidal region.

5. The component of claim 1, wherein the instructions, when executed by the processor circuitry, may further cause the processor circuitry to:
train the neuro-capability map plugin off-line once per robot-action pair.

6. The component of claim 5, wherein the action is performable by the robot a plurality of times using the neural network with the neuro-capability map plugin embedded therein.

7. The component of claim 1, wherein the kinematic capability attributes comprise a success rate index of the action, wherein the action is likely to be successful when the success rate index is greater than a threshold index.

8. The component of claim 1, wherein the kinematic capability attributes comprise a multivariate cue exploitable as an orientation, an approximation cone, a partial trajectory, a geometric primitive, or another expressive geometric.

9. The component of claim 1, wherein the instructions, when executed by the processor circuitry, may further cause the processor circuitry to:
compress the neuro-capability map plugin before the neuro-capability map plugin is published to the robotic skills repository.

10. The component of claim 9, wherein the compression is performed by binary lossless compression or a bit quantization of the neural network.

11. The component of claim 1, wherein the neural network with the neuro-capability map plugin embedded therein is storable within central processing circuitry of a robotic controller.

12. The component of claim 1, wherein central processing circuitry of a robotic controller is operable to perform a plurality of inferences using the neural network with the neuro-capability map plugin embedded therein to infer a plurality of respective inference results, and to select an inference result of the plurality of respective inference results having a highest success rate index for the robot to perform the action.

13. The component of claim 1, wherein the robotic skills repository is hosted in a cloud-based environment.

14. A robotic system, comprising:
a robot; and
robotic controller circuitry operable to:
obtain, from a robotic skills repository, a neuro-capability map plugin, which is a continuous or semi-continuous resolution neural network component encoded with kinematic capability attributes with respect to an action to be performed by a robot in a workspace; and
represent and store the neuro-capability map plugin into a neural network.

15. The robotic system of claim 14, wherein the robotic controller circuitry is further operable to:
perform an inference using the neural network with the neuro-capability map plugin embedded therein;
perform path planning based on a result of the inference; and
control the robot to perform the action based on a planned path.

16. The robotic system of claim 14, wherein the robotic controller circuitry is further operable to:
perform a plurality of inferences using the neural network with the neuro-capability map plugin embedded therein;
select or process an inference result having a highest success rate index for the robot as a probabalistic model of the action; and
control the robot to perform the action based on the selected inference result.
